(19) United States
(12) Patent Application Publication
(10) Pub. No.: US 2007/0021441 A1
(43) Pub. Date: Jan. 25, 2007

(54) Fungicidal mixtures for fighting against rice pathogens

(76) Inventors: Jordi Tormo i Blasco, Laudenbach (DE); Thomas Grote, Wachenheim (DE); Maria Scherer, Godramstein (DE); Reinhard Stierl, Freinsheim (DE); Siegfried Strathmann, Limburgerhof (DE); Ulrich Schöfl, Bruhl (DE)

Correspondence Address: BIRCH STEWART KOLASCH & BIRCH, PO BOX 747, FALLS CHURCH, VA, 22040-0747, US

(21) Appl. No.: 10/570,876

(22) PCT Filed: Sep. 14, 2004
(86) PCT No.: PCT/EP04/10241

§ 371 Date: Mar. 7, 2006

(30) Foreign Application Priority Data
Sep. 22, 2003 (DE) 103-44-147.6
May 5, 2004 (DE) 10-2004-022-684.9

(51) Int. Cl. A01N 43/90; A01N 43/38

(52) U.S. Cl. 514/259.31; 514/417

(57) ABSTRACT

Fungicidal mixtures for controlling rice pathogens, which mixtures comprise, as active components,
1) the triazolopyrimidine derivative of the formula I, 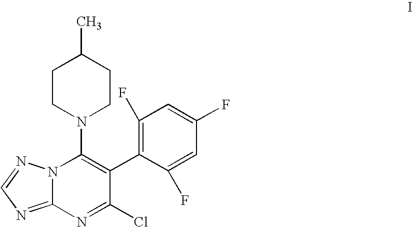 and 2) a phthalimide derivative II selected from the group consisting of
a) captan of the formula IIa, 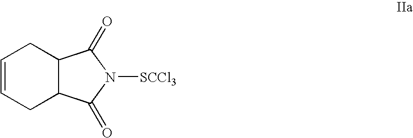 and
b) folpet of the formula IIb, 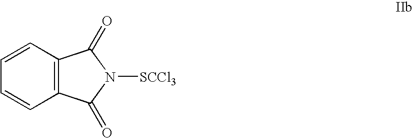 in a synergistically effective amount, methods for controlling rice pathogens using mixtures of the compound I with the compounds II, the use of the compound I with the compounds II for preparing such mixtures and compositions comprising these mixtures are described.

The present invention relates to fungicidal mixtures for controlling rice pathogens, which mixtures comprise, as active components,
1) the triazolopyrimidine derivative of the formula I, 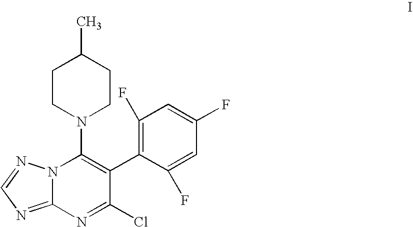
   and
2) a phthalimide derivative II selected from the group consisting of
   a) captan of the formula IIa, 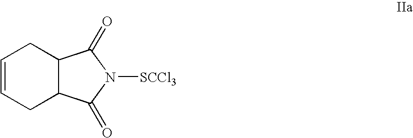
   and
   b) folpet of the formula IIb, 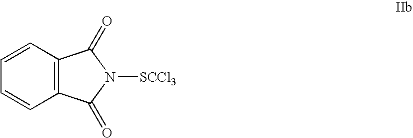
      in a synergistically effective amount.

Moreover, the invention relates to a method for controlling rice pathogens using mixtures of the compound I with the compounds II and to the use of the compound I with the compounds II for preparing such mixtures and compositions comprising these mixtures.

The compound I, 5-chloro-7-(4-methylpiperidin-1-yl)-6-(2,4,6-trifluorophenyl)[1,2,4]triazolo[1,5-a]pyrimidine, its preparation and its action against harmful fungi are known from the literature (WO 98/46607).

The phthalimide derivatives II, 2-trichloromethylsulfanyl-3a,4,7,7a-tetrahydroisoindole-1,3-dione (IIa; common name: captan) and 2-trichloromethylsulfanylisoindole-1,3-dione (IIb; common name: folpet), their preparation and their action against harmful fungi are liekwise known from the literature (U.S. Pat. No. 2,553,770; U.S. Pat. No. 2,553,771; U.S. Pat. No. 2,553,776). The phthalimide derivatives II have been commercially established for a long time as fungicides, mainly against Oomycetes.

Mixtures of triazolopyrimidine derivatives with captan are proposed in a general manner in EP-A 988 790. The compound I is embraced by the general disclosure of this publication, but not explicitly mentioned. Accordingly, the combination of compound I with captan is novel. Folpet is not mentioned in EP-A 988 790.

The synergistic mixtures known from EP-A 988 790 are described as being fungicidally active against various diseases of cereals, fruit and vegetable, for example mildew on wheat and barley or gray mold on apples.

However, the fungicidal action of the known mixtures is not always entirely satisfactory.

It is an object of the present invention to provide, with a view to an effective control of rice pathogens at application rates which are as low as possible, mixtures which, at a reduced total amount of active compounds applied, have an improved effect against the rice pathogens.

Owing to the special cultivation conditions of rice plants, the requirements that a rice fungicide has to meet are considerably different from those that fungicides used in cereal or fruit growing have to meet. There are differences in the application method: in addition to the much-used foliar application in modern rice cultivation the fungicide is usually applied directly onto the soil during or shortly after sowing. The fungicide is taken up into the plant via the roots and transported in the sap of the plant to the plant parts to be protected. In contrast, in cereal or fruit growing, the fungicide is usually applied onto the leaves or the fruits; accordingly, in these crops the systemic action of the active compounds is considerably less important.

Moreover, rice pathogens are typically different from those in cereals or fruit. Pyricularia oryzae and Corticium sasakii (syn. Rhizoctonia solani) are the pathogens of the most significant diseases in rice plants. Rhizoctonia solani is the only pathogen of agricultural significance from the subclass Agaricomycetidae. This fungus attacks the plant not via spores like most other fungi but via a mycelium infection.

For these reasons, findings concerning the fungicidal action in the cultivation of cereals or fruit cannot be transferred to rice crops.

Practical agricultural experience has shown that the repeated and exclusive application of an individual active compound in the control of harmful fungi leads in many cases to the rapid selection of fungus strains which have developed natural or adapted resistance against the active compound in question. Effective control of these fungi with the active compound in question is then no longer possible.

To reduce the risk of selection of resistant fungus strains, mixtures of different active compounds are nowadays preferably employed for controlling harmful fungi. By combining active compounds having different mechanisms of action, it is possible to ensure a successful control over a relatively long period of time.

It is an object of the present inventions to provide, with a view to effective resistance management and an effective control of rice pathogens at application rates which are as low as possible, mixtures which, at a reduced total amount of active compounds applied, have an improved effect against the harmful fungi.

We have found that this object is achieved by the mixtures defined at the outset. Surprisingly, it has been found that the mixtures according to the invention of the triazolopyrimidine derivative I with the phthalimide derivatives II are considerably more active against pice pathogens than the mixtures, proposed in EP-A 988 790, of the structurally similar triazolopyrimidines A or B with captan.

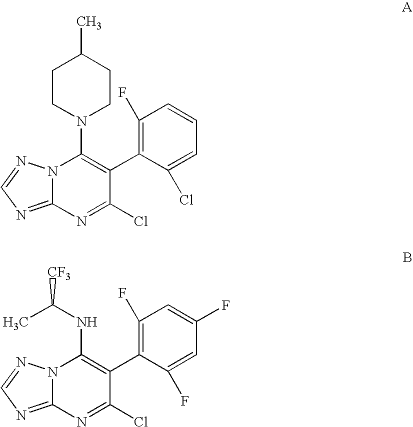

Moreover, we have found that simultaneous, that is joint or separate, application of the compound I and one of the compounds II or successive application of the compounds I and one of the compounds II allows better control of rice-pathogenic harmful fungi than is possible with the individual compounds.

When preparing the mixtures, it is preferred to employ the pure active compounds I and IIa or IIb, to which further active compounds against harmful fungi or other pests, such as insects, arachnids or nematodes, or else herbicidal or growth-regulating active compounds or fertilizers can be added as required.

Other suitable fungicides in the above sense are in particular fungicides selected from the following group:
acylalanines, such as benalaxyl, metalaxyl, ofurace or oxadixyl,
amine derivatives, such as aldimorph, dodemorph, fenpropimorph, fenpropidin, guazatine, iminoctadine, spiroxamine or tridemorph,
anilinopyrimidines, such as pyrimethanil, mepanipyrim or cyprodinyl,
antibiotics, such as cycloheximide, griseofulvin, kasugamycin, natamycin, polyoxin or streptomycin,
azoles, such as bitertanol, bromoconazole, cyproconazole, difenoconazole, dinitroconazole, enilconazole, epoxiconazole, fenbuconazole, fluquinconazole, flusilazole, flutriafol, hexaconazole, imazalil, ipconazole, metconazole, myclobutanil, penconazole, propiconazole, prochloraz, prothioconazole, simeconazole, tebuconazole, tetraconazole, triadimefon, triadimenol, triflumizole or triticonazole,
dicarboximides, such as iprodione, myclozolin, procymidone or vinclozolin,
dithiocarbamates, such as ferbam, nabam, maneb, mancozeb, metam, metiram, propineb, polycarbamate, thiram, ziram or zineb,
heterocyclic compounds, such as anilazine, benomyl, boscalid, carbendazim, carboxin, oxycarboxin, cyazofamid, dazomet, dithianon, famoxadone, fenamidone, fenarimol, fuberidazole, flutolanil, furametpyr, isoprothiolane, mepronil, nuarimol, picobenzamid, probenazole, proquinazid, pyrifenox, pyroquilon, quinoxyfe, silthiofam, thiabendazole, thifluzamide, thiophanate-methyl, tiadinil, tricyclazole or triforine,
copper fungicides, such as Bordeaux mixture, copper acetate, copper oxychloride or basic copper sulfate,
nitrophenyl derivatives, such as binapacryl, dinocap, dinobuton or nitrophthal-isopropyl,
phenylpyrroles, such as fenpiclonil or fludioxonil,
sulfur,
other fungicides, such as acibenzolar-S-methyl, benthiavalicarb, carpropamid, chlorothalonil, cyflufenamid, cymoxanil, diclomezine, diclocymet, diethofencarb, edifenphos, ethaboxam, fenhexamid, fentin-acetate, fenoxanil, ferimzone, fluazinam, fosetyl, fosetyl-aluminum, iprovalicarb, hexachlorobenzene, metrafenone, pencycuron, propamocarb, phthalide, tolclofos-methyl, quintozene or zoxamide,
strobilurins, such as azoxystrobin, dimoxystrobin, fluoxastrobin, kresoxim-methyl, metominostrobin, orysastrobin, picoxystrobin, pyraclostrobin or trifloxystrobin,
sulfenic acid derivatives, such as captafol, dichlofluanid or tolylfluanid,
cinnamides and analogous compounds, such as dimethomorph, flumetover or flumorph.

In one embodiment of the mixtures according to the invention, a further fungicide III or two fungicides III and IV are added to the compounds I and II.

Preference is given to mixtures of the compounds I and II with a component III. Particular preference is given to mixtures of the compounds I and IIa or IIb.

The mixtures of the compounds I and II, or the compounds I and the compound II used simultaneously, that is jointly or separately, exhibit outstanding action against rice pathogens from the class of the Ascomycetes, Deuteromycetes and Basidiomycetes. They can be used for the treatment of seed as well as as foliar- and soil-acting fungicides.

They are especially important for controlling harmful fungi on rice plants and their seeds, such as Bipolaris and Drechslera species and Pyricularia oryzae. They are particularly suitable for controlling rice blast caused by Pyricularia oryzae.

Moreover, the combination of compounds I and II according to the invention is also suitable for controlling other pathogens, such as Septoria and Puccinia species in cereals and Alternaria and Botrytis species in fruit, vegetables and grapevines, for example.

They can also be used in the protection of materials (e.g. the protection of wood), for example against Paecilomyces variotii.

The compound I and the compound IIa or IIb can be applied simultaneously, that is jointly or separately, or in succession, the sequence, in the case of separate application, generally not having any effect on the result of the control measures.

The compound I and the compounds IIa and IIb are usually applied in a weight ratio of from 100:1 to 1:100, preferably from 10:1 to 1:50, in particular from 5:1 to 1:20.

Depending on the type of compound and the desired effect, the application rates of the mixtures according to the invention are from 5 g/ha to 2000 g/ha, preferably from 50 to 1500 g/ha, in particular from 50 to 1000 g/ha.

Correspondingly, the application rates of the compound I are generally from 1 to 1500 g/ha, preferably from 10 to 1200 g/ha, in particular from 20 to 900 kg/ha.

Correspondingly, the application rates of the compound IIa or IIb are generally from 1 to 2000 g/ha, preferably from 10 to 1500 g/ha, in particular from 20 to 1000 g/ha.

In the treatment of seed, the application rates of the mixture are generally from 1 to 1000 g/100 kg of seed, preferably from 1 to 200 g/100 kg, in particular from 5 to 100 g/100 kg.

In the control of harmful fungi which are pathogenic for rice plants, the separate or joint application of the compounds I and the compound IIa or IIb or of the mixtures of the compound I and the compound IIa or IIb is carried out by spraying or dusting the seeds, the seedlings, the plants or the soils before or after sowing of the plants or before or after emergence of the plants. The application of the compounds preferably takes place jointly or separately by spraying the leaves. The application of the compounds can also take place by applying granules or by dusting the

The mixtures according to the invention or the compounds I and II can be converted into the customary formulations, for example solutions, emulsions, suspensions, dusts, powders, pastes and granules. The application form depends on the particular purpose; in each case, it should ensure a fine and uniform distribution of the compound according to the invention.

The formulations are prepared in a known manner, for example by extending the active compound with solvents and/or carriers, if desired using emulsifiers and dispersants. Solvents/auxiliaries which are suitable are essentially:
water, aromatic solvents (for example Solvesso products, xylene), paraffins (for example mineral fractions), alcohols (for example methanol, butanol pentanol, benzyl alcohol), ketones (for example cyclohexanone, gamma-butyrolactone), pyrrolidones (NMP, NOP), acetates (glycol diacetate), glycols, fatty acid dimethylamides, fatty acids and fatty acid esters. In principle, solvent mixtures may also be used,
carriers such as ground natural minerals (for example kaolins, clays, talc, chalk) and ground synthetic minerals (for example highly disperse silica, silicates); emulsifiers such as nonionic and anionic emulsifiers (for example polyoxyethylene fatty alcohol ethers, alkylsulfonates and arylsulfonates) and dispersants such as lignin-sulfite waste liquors and methylcellulose.

Suitable surfactants are alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenyl ether, ethoxylated isooctylphenol, octylphenol, nonylphenol, alkylphenyl polyglycol ethers, tributylphenyl polyglycol ether, tristearylphenyl polyglycol ether, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignin-sulfite waste liquors and methylcellulose.

Substances which are suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, for example toluene, xylene, paraffin, tetrahydronaphthalene, alkylated naphthalenes or their derivatives, methanol, ethanol, propanol, butanol, cyclohexanol, cyclohexanone, isophorone, strongly polar solvents, for example dimethyl sulfoxide, N-methylpyrrolidone and water.

Powders, materials for spreading and dustable products can be prepared by mixing or concomitantly grinding the active substances with a solid carrier.

Granules, for example coated granules, impregnated granules and homogeneous granules, can be prepared by binding the active compounds to solid carriers. Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders and other solid carriers.

In general, the formulations comprise from 0.01 to 95% by weight, preferably from 0.1 to 90% by weight, of the active compounds. The active compounds are employed in a purity of from 90% to 100%, preferably 95% to 100% (according to NMR spectrum).

The following are examples of formulations: 1. Products for dilution with water

A) Water-Soluble Concentrates (SL)

10 parts by weight of the active compounds are dissolved in water or in a water-soluble solvent. As an alternative, wetters or other auxiliaries are added. The active compound dissolves upon dilution with water.

B) Dispersible Concentrates (DC)

20 parts by weight of the active compounds are dissolved in cyclohexanone with addition of a dispersant, for example polyvinylpyrrolidone. Dilution with water gives a dispersion.

C) Emulsifiable Concentrates (EC)

15 parts by weight of the active compounds are dissolved in xylene with addition of calcium dodecylbenzenesulfonate and castor oil ethoxylate (in each case 5% strength). Dilution with water gives an emulsion.

D) Emulsions (EW, EO)

40 parts by weight of the active compounds are dissolved in xylene with addition of calcium dodecylbenzenesulfonate and castor oil ethoxylate (in each case 5% strength). This mixture is introduced into water by means of an emulsifier (Ultraturax) and made into a homogeneous emulsion. Dilution with water gives an emulsion.

E) Suspensions (SC, OD)

In an agitated ball mill, 20 parts by weight of the active compounds are comminuted with addition of dispersant, wetters and water or an organic solvent to give a fine active compound suspension. Dilution with water gives a stable suspension of the active compound.

F) Water-Dispersible Granules and Water-Soluble Granules (WG, SG)

50 parts by weight of the active compounds are ground finely with addition of dispersants and wetters and made into water-dispersible or water-soluble granules by means of technical appliances (for example extrusion, spray tower, fluidized bed). Dilution with water gives a stable dispersion or solution of the active compound.

G) Water-Dispersible Powders and Water-Soluble Powders (WP, SP)

75 parts by weight of the active compounds are ground in a rotor-stator mill with addition of dispersant, wetters and silica gel. Dilution with water gives a stable dispersion or solution of the active compound.

2. Products to be Applied Undiluted

H) Dustable Powders (DP)

5 parts by weight of the active compounds are ground finely and mixed intimately with 95% of finely divided kaolin. This gives a dustable product.

I) Granules (GR, FG, GG, MG)

0.5 part by weight of the active compounds is ground finely and associated with 95.5% carriers. Current methods are extrusion, spray-drying or the fluidized bed. This gives granules to be applied undiluted.

J) ULV Solutions (UL)

10 parts by weight of the active compounds are dissolved in an organic solvent, for example xylene. This gives a product to be applied undiluted.

The active compounds can be used as such, in the form of their formulations or the use forms prepared therefrom, for example in the form of directly sprayable solutions, powders, suspensions or dispersions, emulsions, oil dispersions, pastes, dustable products, materials for spreading, or granules, by means of spraying, atomizing, dusting, spreading or pouring. The use forms depend entirely on the intended purposes; it is intended to ensure in each case the finest possible distribution of the active compounds according to the invention.

Aqueous use forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. Alternatively, it is possible to prepare concentrates composed of active substance, wetter, tackifier, dispersant or emulsifier and, if appropriate, solvent or oil, and such concentrates are suitable for dilution with water.

The active compound concentrations in the ready-to-use preparations can be varied within relatively wide ranges. In general, they are from 0.0001 to 10%, preferably from 0.01 to 1%.

The active compounds may also be used successfully in the ultra-low-volume process (ULV), it being possible to apply formulations comprising over 95% by weight of active compound, or even to apply the active compound without additives.

Various types of oils, wetters, adjuvants, herbicides, fungicides, other pesticides, or bactericides may be added to the active compounds, if appropriate just immediately prior to use (tank mix). These agents are usually admixed with the agents according to the invention in a weight ratio of 1:10 to 10:1.

The compounds I and II or the mixtures or the corresponding formulations are applied by treating the harmful fungi or the plants, seeds, soils, areas, materials or spaces to be kept free from them with a fungicidally effective amount of the mixture or, in the case of separate application, of the compounds I and II. Application can be carried out before or after infection by the harmful fungi.

The fungicidal action of the compound and the mixtures can be demonstrated by the experiments below:

The active compounds, separately or jointly, were prepared as a stock solution with 0.25% by weight of active compound in acetone or DMSO. 1% by weight of the emulsifier Uniperol® EL (wetting agent having emulsifying and dispering action based on ethoxylated alkylphenols) was added to this solution, and the solution was diluted with water to the desired concentration.

### USE EXAMPLE

### Protective Activity Against Rice Blast Caused by Pyricularia oryzae

Leaves of rice seedlings of the cultivar “Tai-Nong 67”, which had been grown in pots, were sprayed to runoff point with an aqueous suspension having the concentration of active compounds stated below. The next day, the plants were inoculated with an aqueous spore suspension of Pyricularia oryzae. The test plants were then placed in climatized chambers at 22-24° C. and 95-99% relative atmospheric humidity for 6 days. The extent of the development of the infection on the leaves was then determined visually.

The visually determined values for the percentage of infected leaf areas were converted into efficacies as % of the untreated control:

The efficacy (E) is calculated as follows using Abbot's formula:
E=(1−α/β)·100

α corresponds to the fungicidal infection of the treated plants in % and

β corresponds to the fungicidal infection of the untreated (control) plants in %

An efficacy of 0 means that the infection level of the treated plants corresponds to that of the untreated control plants; an efficacy of 100 means that the treated plants were not infected.

The expected efficacies of the mixtures of active compounds are determined using

Colby's formula (Colby, S. R. “Calculating synergistic and antagonistic responses of herbicide combinations”, Weeds 15, 20-22, 1967) and compared with the observed efficacies.

Colby's formula:
E=x+y−x·y/100
E expected efficacy, expressed in % of the untreated control, when using the mixture of the active compounds A and B at the concentrations a and
x efficacy, expressed in % of the untreated control, when using active compound A at the concentration a
y efficacy, expressed in % of the untreated control, when using active compound B at the concentration b

The comparative compounds used were compounds A and B, known from the captan mixtures described in EP-A 988 790:

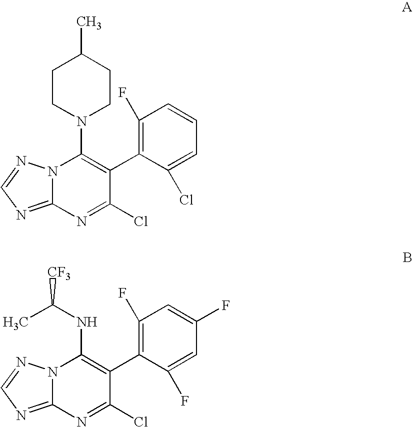

TABLE A
Individual active compounds

| | | Concentration of | |
|---|---|---|---|
| | | active compound in | |
| | Active | the spray liquor | Efficacy in % of the |
| Example | compound | [ppm] | untreated control |
| 1 | — | control | (76% infection) |
| | | (untreated) | |
| 2 | I | 63 | 48 |
| | | 16 | 21 |
| 3 | IIa | 63 | 35 |
| | (captan) | 16 | 0 |
| 4 | IIb | 63 | 8 |
| | (folpet) | 16 | 0 |
| 5 | Comparative | 63 | 61 |
| | compound A | 16 | 35 |
| 6 | Comparative | 63 | 61 |
| | compound B | 16 | 48 |

TABLE B
Mixtures according to the invention

| | Mixture of active compounds; | Observed | Calculated |
|---|---|---|---|
| Example | concentration; mixing ratio | efficacy | efficacy*) |
| 7 | I + IIa | 91 | 48 |
| | 63 + 16 ppm | | |
| | 4:1 | | |
| 8 | I + IIa | 87 | 49 |
| | 16 + 63 ppm | | |
| | 1:4 | | |
| 9 | I + IIb | 80 | 48 |
| | 63 + 16 ppm | | |
| | 4:1 | | |
| 10 | I + IIb | 74 | 28 |
| | 16 + 63 ppm | | |
| | 1:4 | | |

*)efficacy calculated using Colby's formula

TABLE C
comparative tests - combinations of the
active compounds known from EP-A 988 790

| | Mixture of active compounds; | Observed | Calculated |
|---|---|---|---|
| Example | concentration; mixing ratio | efficacy | efficacy*) |
| 11 | A + IIa | 61 | 61 |
| | 63 + 16 ppm | | |
| | 4:1 | | |
| 12 | A + IIa | 35 | 57 |
| | 16 + 63 ppm | | |
| | 1:4 | | |
| 13 | A + IIb | 48 | 61 |
| | 63 + 16 ppm | | |
| | 4:1 | | |
| 14 | A + IIb | 35 | 40 |
| | 16 + 63 ppm | | |
| | 1:4 | | |
| 15 | B + IIa | 48 | 61 |
| | 63 + 16 ppm | | |
| | 4:1 | | |
| 16 | B + IIa | 35 | 66 |
| | 16 + 63 ppm | | |
| | 1:4 | | |
| 17 | B + IIb | 48 | 61 |
| | 63 + 16 ppm | | |
| | 4:1 | | |
| 18 | B + IIb | 48 | 52 |
| | 16 + 63 ppm | | |
| | 1:4 | | |

*)efficacy calculated using Colby's formula

The test results show that the mixtures according to the invention have, at comparable application rates, considerably higher activity than the captan mixtures known from EP A 988 790, even though the comparative compounds, as individual active compounds, are more active than compound I.

1. A fungicidal mixture which mixture comprises
1) a triazolopyrimidine derivative compound of formula I 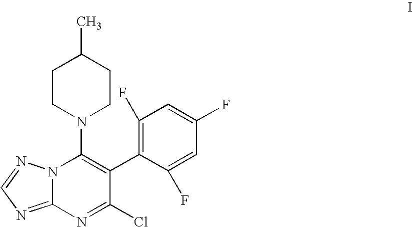
and
2) a phthalimide derivative compound of formula II selected from the group consisting of
a) captan of formula IIa, 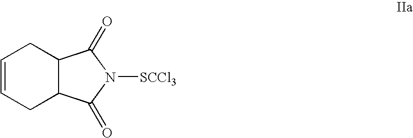
and
b) folpet of formula IIb, 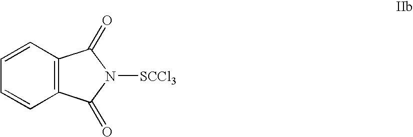
in a synergistically effective amount.

2. The fungicidal mixture as claimed in claim 1 comprising the compound of the formula I and the compound of the formula II in a weight ratio of from 100:1 to 1:100.

3. The fungicidal mixture as claimed in claim 1 or 2 comprising, as the phthalimide derivative, the captan of the formula IIa.

4. The fungicidal mixture as claimed in claim 1 or 2 comprising, as the phthalimide derivative, the folpet of the formula IIb.

5. A fungicidal composition comprising a liquid or solid carrier and the mixture as claimed in claim 1.

6. A method for controlling rice-pathogenic harmful fungi, which comprises treating the fungi, their habitat or the seed, the soil or the plants to be protected against fungal attack with an effective amount of the compound of formula I and one of the compounds of formula II as set forth in claim 1.

7. The method according to claim 6, wherein the compounds of formulas I and II are applied simultaneously, that is jointly or separately, or in succession.

8. The method according to claim 6, wherein the mixture is applied in an amount of from 5 g/ha to 2000 g/ha.

9. The method according to claim 6, wherein the mixture is applied in an amount of from 1 to 1000 g/100 kg of seed.

10. The method according to claim 5, wherein the harmful fungus Pyricularia oryzae is controlled.

11. Seed comprising the mixture as claimed in claim 1 in an amount of from 1 to 1000 g/100 kg.

12. A process for preparing a composition as defined in claim 5 comprising extending the compounds of formulas I and II with solvents and/or carriers.
